(19) United States
(12) Patent Application Publication
(10) Pub. No.: US 2013/0155301 A1
(43) Pub. Date: Jun. 20, 2013

(54) IMAGE PICKUP APPARATUS, IMAGE PICKUP METHOD, AND MACHINE-READABLE STORAGE MEDIUM

(71) Applicant: Samsung Electronics Co., Ltd., Gyeonggi-do (KR)

(72) Inventor: Shinri TAKAHASHI, Kanagawa (JP)

(73) Assignee: Samsung Electronics Co., Ltd., Gyeonggi-do (KR)

(21) Appl. No.: 13/716,809

(22) Filed: Dec. 17, 2012

(30) Foreign Application Priority Data
Dec. 16, 2011 (JP) 2011-276468

(51) Int. Cl. H04N 5/235

(52) U.S. Cl. CPC H04N 5/2353
USPC 348/296

(57) ABSTRACT

An image pickup apparatus and method are provided. The method includes performing a first and second reset operations with respect to a charge accumulated in first and second pixel lines, respectively, of an image pickup device, each of the first and second pixel lines having a plurality of pixels; traveling a light shielding member on the first and second pixel lines, respectively when first and second respective exposure times elapse from the first and second reset operations, respectively; outputting the charge accumulated in the first and second pixel lines, respectively, as first and second pixel data, respectively, after the light shielding member travels on the first and second pixel lines, respectively; and computing a first calibration value for the first pixel line and a second calibration value for the second pixel line based on the first and second pixel data and the first and second exposure times.

### PRIORITY

This application claims priority under 35 U.S.C. §119(a) to a Japanese Patent Application filed in the Japanese Patent and Trademark Office and assigned Serial No. JP 2011-276468 on Dec. 16, 2011, the entire content of which is incorporated herein by reference.

### BACKGROUND OF THE INVENTION

1. Field of the Invention

The present invention relates generally to an image pickup apparatus and method, and more particularly, to an image pickup apparatus and method for changing accumulation times of charges for pixel lines having a preset pixel width to create an image whose exposure times are different from each other for pixel lines and accurately reduce an exposure unevenness based on the image.

2. Description of the Related Art

In recent years, digital cameras, including Digital Single Lens Reflex (DSLR) cameras, to which a focal plane shutter is mounted and which uses electronic front shutter technology for controlling exposure starting timings for pixel lines (i.e., pixel rows and pixel columns), such that the exposure starting timings can satisfy the operation characteristics of a mechanical rear shutter, have been commercialized. In a conventional digital camera using a mechanical front shutter, when a live view state transitions to a still image photographing operation, a mechanical shutter is charged to convert an image pickup device into a light shielding state, and then a mechanical front shutter and a mechanical rear shutter travel (i.e., pass in sequence in front of an image pickup device) to perform an exposure.

If the electronic front shutter technology is used, a mechanical shutter does not need to be closed when a live view transitions to a still image photographing operation, and a time lag or a shutter lag from a photographing instruction to a starting of photographing can be restrained minimally. Further, the mechanical shutter itself can be miniaturized or low-priced.

However, there is an exposure unevenness problem when using conventional electronic front shutter technology. Exposure unevenness refers to dispersion in an amount of exposure for areas of a screen. A main factor affecting exposure unevenness includes an error between travel characteristics of an electronic front shutter and travel characteristics of a mechanical rear shutter. In particular, the travel characteristics of a mechanical shutter vary according to a posture difference, an environment such as temperature and humidity, or a change due to a lapse of time, whereas an electronic front shutter is accompanied by an exposure unevenness, since its travel characteristics do not vary according to these conditions.

Further, since the electronic front shutter travels on an imaging plane whereas the mechanical shutter travels while being spaced apart from the imaging plane, an error is also generated by an incidence angle of a light flux with respect to the imaging plane. The errors may be varied by a focal distance of a lens, a zoom position, an aperture value, etc. In order to limit an exposure unevenness caused by the errors, technology for calibrating travel characteristics of an electronic front shutter based on the above-described conditions has been proposed. However, the technology for calibrating travel characteristics of an electronic front shutter based on these conditions does not monitor an exposure amount in real time to correct travel characteristics, and therefore, this technology has insufficient calibration preciseness.

In order to address this limitation in calibration technology, another technology for applying a gain to each pixel line to calibrate an image, such that a difference between a live view image shortly before a still image is photographed and an exposed image obtained by actually traveling an electronic front shutter and a mechanical rear shutter, has been proposed (See, e.g., Japanese Unexamined Patent Publication No. 2008-219523). Further, another technology for feeding back travel characteristics of an electronic front shutter to minimally restrain an error has also been proposed (See, e.g., Japanese Unexamined Patent Publication Nos. 2008-022198 and 2008-219524). According to the technology, a calibration may be efficiently processed, but a time lag is present in exposure between a live view image shortly before and an image using a mechanical rear shutter. In particular, with conventional technologies, a calibration may not be accurately performed when a subject moves at a high speed.

Meanwhile, another application technology using the electronic front shutter technology has been proposed. More specifically, an application technology of alternately changing exposure time for a plurality of pixel lines and synthesizing a plurality of acquired exposed images to obtain a wide dynamic range while deteriorating resolution a little also has been proposed (for example, Japanese Unexamined Patent No. 2008-118573). In such a synthesis, an exposure difference of synthesized images is stored in advance, and multiplication is performed by the exposure difference and then addition is performed.

However, if an exposure unevenness problem is present according to the electronic front shutter technology, an error is generated between an actual exposure difference and a calculated exposure difference, making it difficult to properly synthesize an image.

### SUMMARY OF THE INVENTION

Accordingly, an aspect of the present invention is to solve at least the above-described problems occurring in the prior art, and to provide at least the advantages described below. Accordingly, an aspect of the present invention provides a method and apparatus for changing accumulation times of charges for pixel lines having a preset pixel width (the number of pixels) to create an image whose exposure times are different from each other for pixel lines and precisely reduce an exposure unevenness based on the image.

According to an aspect of the present invention, an image pickup apparatus is provided. The apparatus includes an image pickup device including a first pixel line and a second pixel line, each of which has a plurality of pixels; a first resetting part for performing a first reset operation with respect to a charge accumulated in the first pixel line; a second resetting part for performing a second reset operation with respect to a charge accumulated in the second pixel line; a travel control part for traveling a light shielding member above the first pixel line when a first exposure time elapses from the first reset operation, and traveling the light shielding member above the second pixel line when a second exposure time elapses from the second reset operation; a pixel data output part for outputting the charge accumulated in the first pixel line as first pixel data for a current photographing operation after the light shielding member travels above the first pixel line, and outputting the charge accumulated in the second pixel line as second pixel data for the current photographing operation after the light shielding member travels above the second pixel line; and a computation part for computing a first calibration value for the first pixel line and a second calibration value for the second pixel line based on the first pixel data, the second pixel data, the first exposure time, and the second exposure time.

According to another aspect of the present invention, an image pickup method is provided. The method includes performing a first reset operation with respect to a charge accumulated in a first pixel line of an image pickup device, each of the first and second pixels lines having a plurality of pixels; performing a second reset operation with respect to a charge accumulated in the second pixel line; traveling a light shielding member on the first pixel line when a first exposure time elapses from the first reset operation, and traveling a light shielding member above the first pixel line when a first exposure time elapses from the first reset operation, and traveling the light shielding member above the second pixel line when a second exposure time elapses from the second reset operation; outputting the charge accumulated in the first pixel line as first pixel data for a current photographing operation after the light shielding member travels above the first pixel line, and outputting the charge accumulated in the second pixel line as second pixel data the current photographing operation after the light shielding member travels above the second pixel line; and computing a first calibration value for the first pixel line and a second calibration value for the second pixel line based on the first pixel data, the second pixel data, the first exposure time, and the second exposure time.

According to another aspect of the present invention, a non-transitory machine-readable storage medium that records a program for executing an image pickup method is provided. The method includes performing a first reset operation with respect to a charge accumulated in a first pixel line of an image pickup device, each of the first and second pixels lines having a plurality of pixels; performing a second reset operation with respect to a charge accumulated in the second pixel line; traveling a light shielding member above the first pixel line when a first exposure time elapses from the first reset operation, and traveling the light shielding member above the second pixel line when a second exposure time elapses from the second reset operation; outputting the charge accumulated in the first pixel line as first pixel data for a current photographing operation after the light shielding member travels above the first pixel line, and outputting the charge accumulated in the second pixel line as second pixel data the current photographing operation after the light shielding member travels above the second pixel line; and computing a first calibration value for the first pixel line and a second calibration value for the second pixel line based on the first pixel data, the second pixel data, the first exposure time, and the second exposure time.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram illustrating a configuration of an image pickup apparatus according to an embodiment of the present invention;

FIG. 2 is a diagram illustrating an example of travel characteristics of an electronic front shutter and a mechanical rear shutter according to an embodiment of the present invention;

FIG. 3 is a diagram illustrating a chart for explaining computation of calibration values by the image pickup apparatus according an embodiment of the present invention;

FIG. 4 is a diagram illustrating an example of smoothing calibration values according to an embodiment of the present invention;

FIG. 5 is a diagram illustrating a chart for explaining application of calibration values to expansion of a dynamic range according to an embodiment of the present invention;

FIG. 6 is a graph illustrating a synthesis result of pixel values when an exposure unevenness is not generated according to an embodiment of the present invention; and

FIG. 7 is a graph illustrating a synthesis result of pixel values when an exposure unevenness is generated according to an embodiment of the present invention.

### DETAILED DESCRIPTION OF EMBODIMENTS OF THE PRESENT INVENTION

Hereinafter, various embodiments of the present invention are described in detail with reference to the accompanying drawings. In the following description, the same elements may be designated by the same reference numerals although they are shown in different drawings.

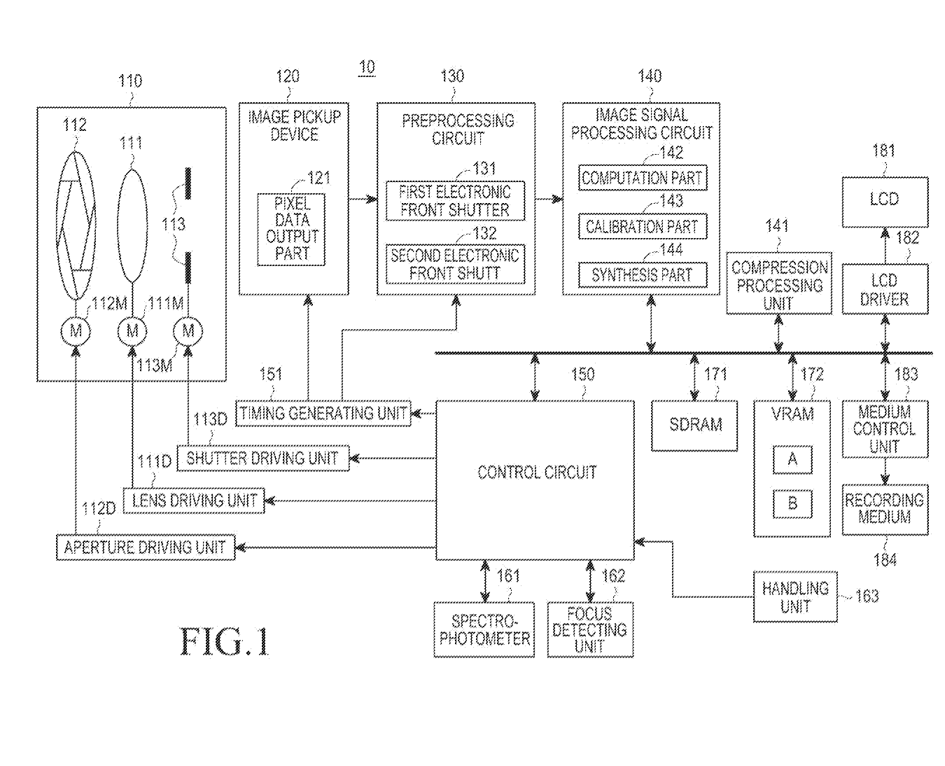

FIG. 1 is a diagram illustrating a configuration of an image pickup apparatus according to an embodiment of the present invention.

Referring to FIG. 1, an image pickup apparatus 10 includes a lens system 110, a lens driving unit 111D, an aperture driving unit 112D, a shutter driving unit 113D, an image pickup device 120, a preprocessing unit 130, an image signal processing circuit 140, a compression processing unit 141, and a control circuit 150.

The image pickup apparatus 10 also includes a timing generating part 151, a spectrophotometer 161, a focus detecting unit 162, a handling member 163 (e.g., a switch), a compression processing circuit 141, a Synchronous Dynamic Random Access Memory (SDRAM) 171, a video RAM (VRAM) 172, a Liquid Crystal Display (LCD) 181, an LCD driving unit 182, a medium control unit 183, and a recording medium 184. The SDRAM 171 and the VRAM 172 may also be referred to as first and second memories.

Some or all of the preprocessing circuit 130, the image signal processing circuit 140, the compression processing circuit 141, the focus detecting unit 162, and the medium control unit 183 may be integrated with the control circuit 150.

The lens system 110 is an optical system that includes at least one lens 111, an aperture 112, and a mechanical rear shutter 113 to transmit light from a subject and form an image on an imaging plane of the image pickup device 120 (i.e., surfaces of pixels). The lens 111 is moved along an optical axis from one side to an opposite side (or vice versa) of the optical axis in order to focus an image of the subject on an imaging plane of the image pickup device 120. The optical lens 111 is symmetrical with respect to an optical axis passing through the center thereof, and the optical axis is defined as the central axis. The aperture 112 is a structure for adjusting an amount of transmitted light (i.e., a light amount). The mechanical rear shutter 113 functions as a light shielding member. The lens system 110 includes first to third motors 111M, 112M, and 113M.

The image pickup device 120 corresponds to a photoelectric conversion device, and includes a plurality of photoelectrically convertible devices for converting light or optical information having transmitted the lens system 110 to be introduced into an electrical signal (i.e., a plurality of pixels disposed in an M by N matrix structure). For example, a Charge Coupled Device (CCD) or a Complementary Metal Oxide Semiconductor (CMOS) may be used as the image pickup device 120.

In order to control an exposure time of the image pickup device 120, the mechanical rear shutter 113 and the electronic front shutter may be applied such that light is shielded when a photographing operation is not performed, but instead such that light is received by the image pickup device 120 only when a photographing operation is performed. Further, operations of the mechanical rear shutter 113 and the electronic front shutter are performed by switching a shutter button (i.e., the handling member 163) connected to the control circuit 150.

The preprocessing circuit 130 processes a digital signal output from the image pickup device 120, generates an image signal by which an image can be processed, and outputs the generated image signal, for example, to the image signal processing circuit 140. The preprocessing circuit 130 writes and reads image data to and from the SDRAM 171.

The image signal processing circuit 140 receives an image signal from the preprocessing circuit 130, performs various image processing on an image signal based on a white balance control value, a gamma (γ) value, a contour emphasis control value, and the like, and generates an image signal after the image processing.

The VRAM 172 is a memory for image display, and has a plurality of channels (i.e., Channel A and Channel B in the example of FIG. 1). The VRAM 172 inputs image data for image display from the SDRAM 171 and outputs image data to the LCD driving part 182. A resolution and a maximum number of colors of the LCD 181 rely on a capacity of the VRAM 172.

The SDRAM 171 is an example of a storage or a memory, and temporarily preserves image data of a photographed image. The SDRAM 171 has a storage capacity for storing a plurality of image data, sequentially maintains image signals during focus control, and outputs an image signal. The SDRAM 171 also preserves an operation program of the control circuit 150. The preprocessing circuit 130 controls the reading of image data from the SDRAM 171 and writing of image data to the SDRAM 171.

The LCD driving part 182 is, for example, a display driving part for receiving image data from the VRAM 172 and displaying an image on the LCD 181.

The LCD 181 is a display part installed in the main body of the image pickup apparatus 10, and displays an image before photographing read from the VRAM 172 (i.e., displays a live view), various setting screens, and a photographed and recorded image. Although the LCD 181 is described as functioning as a display part and the LCD driving part 182 is described as functioning as a display driving part for the display part, embodiments of the present invention are not limited to these examples. For example, an organic Electro Luminescence (EL) display may function as a display part and an organic EL display driving part may function as a display driving part in accordance with embodiments of the present invention.

The medium control part 183 controls writing of image data to the recording media 184 and/or reading of image data or setting information recorded in the recording medium 184.

The recording medium 184 may be, for example, an optical disk (a Compact Disc (CD), a Digital Versatile Disc (DVD), a Blu-ray disc, etc.), a magneto-optical disk, a magnetic disk, a semiconductor storage medium, and the like, and records photographed image data. Here, the medium control part 183 and the recording medium 184 may be detachable from the image pickup apparatus 10.

The compression processing circuit 141 receives an image signal before compression, and compresses an image signal by using, for example, a Joint Photographic Experts Group (JPEG) compression format. The compression processing circuit 141 transmits image data created through the compression, for example, to the medium control part 183.

The handling member 163 may include, for example, up, down, left, and right keys installed in the image pickup apparatus 10, a power switch, a mode dial, and a shutter button, and transmits a handling signal to the control circuit 150 and the like based on a handling by a user. For example, the shutter button may distinguish between a half button press, a full press, and a release by a user. When the shutter button is half-pressed, a handling signal for starting of a focus control is output, and when the half button press is released, a handling signal for completion of a focus control is output. Further, when fully pressed, the shutter button outputs a handling signal for starting of photographing.

The control circuit 150 functions as a computation processing unit and a control unit by a program, and controls processing of various constituent elements installed in the image pickup apparatus 10. The control circuit 150 outputs a signal to the lens driving unit 111D, the aperture driving unit 112D, and/or the shutter driving unit 113D, for example, based on a focus control or an exposure control to drive the lens system 110. Further, the control circuit 150 controls various constituent elements of the image pickup apparatus 10 based on a handling signal from the handling member 163. Meanwhile, although only one control circuit 150 is provided in the present example, a plurality of Central Processing Units (CPUs) may be provided to perform an instruction of a signal system and an instruction of a handling system in accordance with embodiments of the present invention. The control circuit 150 may be referred to as a main control part.

If a handling signal for starting a focus control is received, the control circuit 150 generates a control signal for moving the lens 111 in one direction and outputs the generated control signal to the lens driving unit 111D. Further, if a handling signal for starting of an aperture control is received, the control circuit 150 generates a control signal for adjusting the aperture 112 and outputs the generated control signal to the aperture driving unit 112D. Further, if a handling signal for starting of a shutter control is received, the control circuit 150 generates a control signal for scanning or traveling the mechanical rear shutter 113 and outputs the control signal to the shutter driving unit 113D.

The control circuit 150 also manages a screen display performed by the LCD 181. For example, the control circuit 150 outputs a control signal for displaying a screen selected based on a handling signal output from the handling member 163 on the LCD 181 to the LCD driving part 182.

The timing generating part 151 outputs a timing signal to the image pickup device 120, and controls exposure times of pixels included in the image pickup device 120 or controls reading of charges accumulated in pixels (that is, pixel data or pixel values). The spectrophotometer 161 computes a proper amount of exposure from an image signal received from the image signal processing circuit 140, and determines shutter related data, aperture related data, and gain related data.

The determined shutter related data is provided to the control circuit 150 to control the electronic front shutter through the timing generating part 151 during a live view. The determined aperture related data is provided to the control circuit 150 to control driving of the aperture 112 disposed in the lens 110 through the aperture driving unit 112D. The determined gain related data is provided to the control circuit 150 to control the image signal amplifying unit of the image pickup device 120 or the preprocessing circuit 130.

The focus detecting unit 162 detects a focus by using a contrast component and/or other such components of an image signal output from the image pickup device 120, and the focus related data is provided to the control circuit 150 to adjust a focus while the lens 111 is driven by the lens driving unit 111D.

The lens driving unit 111D generates a driving signal based on a control signal received from the control circuit 150, and transmits the generated driving signal to the first motor 111M to drive the first motor 111M. As a result, the first motor 111M controls a location or a movement of the lens 111.

The aperture driving unit 112D generates a driving signal based on a control signal received from the control circuit 150, and transmits the generated driving signal to the second motor 112M to drive the second motor 112M. As a result, the second motor 112M controls a size of an opening of the aperture 112.

The shutter driving unit 113D generates a driving signal based on a control signal received from the control circuit 150, and transmits the generated driving signal to the third motor 113M, in order to drive the third motor 113M. As a result, the third motor 113M controls an opening location or a movement of the mechanical rear shutter 113.

Meanwhile, a series of processing in the image pickup apparatus 10 may be performed by hardware or may be realized by software of a program in a computer.

In the present example according to an embodiment of the present invention, an amount of charges accumulated by exposure is read after the image pickup device 120 is exposed, but the CMOS sensor generally cannot maintain an amount of charges accumulated at an exposure completion time in the image pickup device even after the exposure is completed and charges are continuously accumulated. However, when data of the entire screen is read, a time gap is related to an exposure difference, if the time gap is present in the timings for reading pixel data.

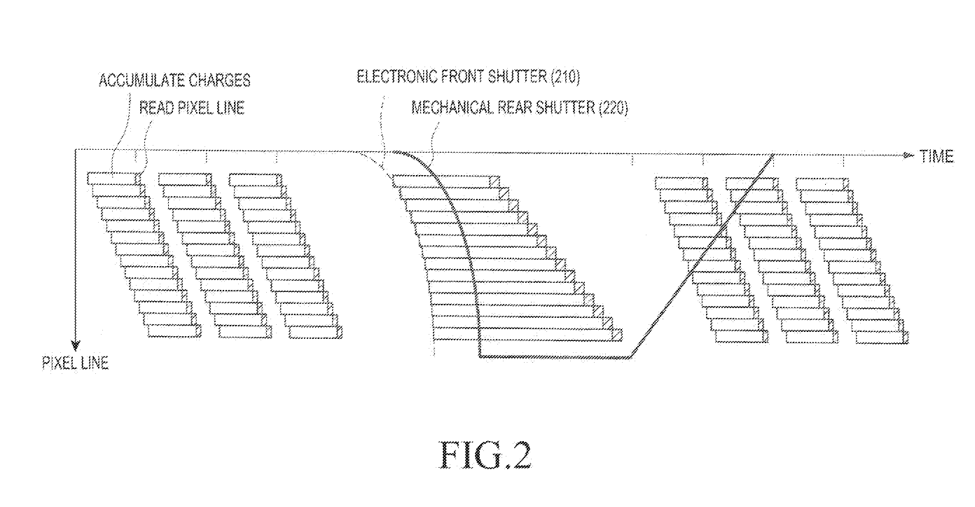

FIG. 2 is a diagram illustrating an example of travel characteristics of an electronic front shutter and a mechanical rear shutter according to an embodiment of the present invention.

Referring to FIG. 2, such an influence can be restrained by alternating timings for starting accumulation of charges for pixel lines, i.e., by allowing pixel lines to have different charge accumulation starting timings. This particular manner of alternating timings is referred to as a rolling shutter.

In order to increase a frame rate during a live view, a reading time of an entire screen of the live view itself is shortened by extracting reading pixels, i.e., by selecting some pixels from which data are read. However, a reading time for reading all pixels increases when a still image is photographed. If a rolling shutter is used to perform a reading operation as in a live view when a still image is photographed, an exposure time lag between an upper pixel line and a lower pixel line increases, and a problem called a focal plane phenomenon occurs. Therefore, a mechanical shutter is often used together with the rolling shutter.

Although a front shutter and a rear shutter are driven after charges of all pixels of an image pickup device start to be accumulated by using a focal plane shutter according to the related art, an electronic front shutter technology for applying an electronic shutter as a front shutter are being recently put to practical use. As shown in FIG. 2, pixels included in an entire screen are uniformly exposed by controlling such that charge accumulation starting timings for pixel lines agree with travel characteristics of a rear shutter. Although charges themselves are continuously accumulated until pixel values are read after the mechanical shutter is closed, light is optically shielded, so that a series problem does not occur, even if an entire pixel reading time is rather long.

However, although the travel characteristics of a mechanical shutter vary according to conditions such as a posture difference of the image pickup apparatus 10, temperature, and a change in time lapse, the travel characteristics of the electronic front shutter do not vary due to the conditions, and therefore, an exposure unevenness is generated by the mismatch. Further, since the electronic front shutter travels on an imaging plane whereas the mechanical rear shutter travels while being spaced apart from an imaging plane, an error is generated in an amount of exposure even due to an incidence angle of a light flux. Further, an amount of exposure varies even due to a focal distance of the lens, a zoom position, an aperture value, and the like. FIG. 2 shows an exposure starting time line 210 by an electronic front shutter and a light shielding timing line 220 by a mechanical rear shutter. The electronic front shutter is realized by an electronic circuit, and when the electronic front shutter travels on an imaging plane, the electronic front shutter sequentially exposes pixel lines forming the imaging plane. Further, since the electronic front shutter is not a mechanical shutter, exposure of pixel lines means that charges accumulated in the pixel lines are reset or removed, that is, the accumulated charges are made to be zero. When a mechanical rear shutter travels above an imaging plane, the mechanical rear shutter is moved to sequentially cover pixel lines.

A method for predicting a change in travel characteristics of the electronic front shutter based on lens information, a posture difference, temperature information, and the like and traveling the electronic front shutter due to travel characteristics according to the change is provided to cope with the problem. The predicted value cannot be defined as being necessarily accurate. Meanwhile, according to an embodiment of the present invention, the image pickup apparatus 10 includes a first electronic front shutter 131 (i.e., a first resetting part) and a second electronic front shutter 132 (i.e., a second resetting part).

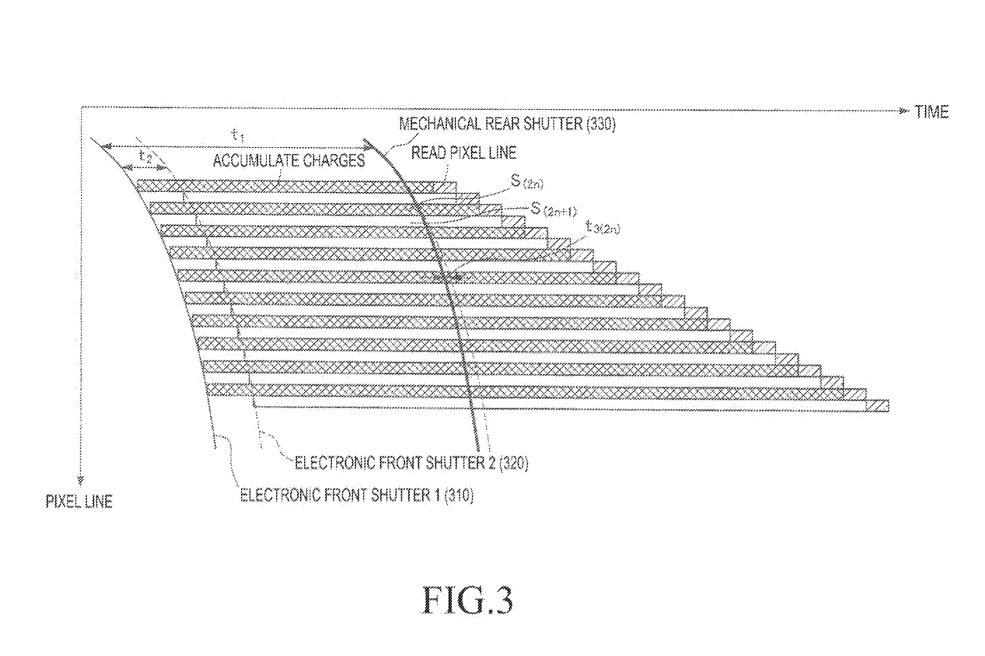

FIG. 3 is a diagram illustrating a chart for explaining computation of calibration values by the image pickup apparatus according to an embodiment of the present invention.

FIG. 3 shows an exposure starting timing line 310 by a first electronic front shutter 131, an exposure starting timing line 320 by a second electronic front shutter 132, and a light shielding timing line 330 by a mechanical rear shutter 113.

Referring to FIG. 3, first pixel lines 2n and second pixel lines 2n+1 are alternately arranged on an imaging plane of the image pickup device 120. Each of the first pixel lines 2n and the second pixel lines 2n+1 has a preset pixel width (the number of pixels). More specifically, each of the first pixel lines 2n and the second pixel lines 2n+1 may have a width of one pixel, and may have a width of a plurality of pixels. In certain cases, in aspects of calibration and computation, each of the first pixel lines 2n and the second pixel lines 2n+1 may not have an excessive pixel width. Here, n is an integer greater than or equal to 1.

The first pixel lines 2n and the second pixel lines 2n+1 are also be referred to as odd-numbered pixel lines and even-numbered pixel lines, respectively, and each of the pixel lines are configured by at least one pixel row or at least one pixel column.

The first electronic front shutter performs an operation (i.e., a first resetting operation) of resetting charges accumulated in the first pixel lines 2n, and the second electronic front shutter performs an operation (i.e., a second resetting operation) of resetting charges accumulated in the second pixel lines 2n+1. The first electronic front shutter 131 and the second electronic front shutter 132 constitute a part of the image pickup device 120, and perform the resetting operations based on a reset signal transmitted from the timing generating part 151. For example, if a desired time comes, an instruction for transmitting a reset signal to the image pickup device 120 is transmitted from the control circuit 150 to the timing generating part 151.

t1 denotes an originally desired exposure time. t2 is a value smaller than t1, and denotes a time gap between travel timings of the first electronic front shutter 131 and the second electronic front shutter 132. t1 corresponds to a first exposure time and t1−t2 corresponds to a second exposure time. The third motor 113M (i.e., a travel control part) travels the mechanical rear shutter 113 above the first pixel lines 2n if t1 elapses from the first resetting operation. Further, the third motor 113M travels the mechanical rear shutter 113 above the second pixel lines 2n+1 if t1−t2 elapses from the second resetting operation. The third motor 113M travels the mechanical rear shutter 113 based on a driving signal transmitted from the shutter driving unit 113D.

A pixel data output part 121 constituting a part of the image pickup device 120 outputs charges accumulated in the first pixel lines 2n as an accumulated value S(2n) of pixel values after the mechanical rear shutter 113 travels above the first pixel lines 2n. Further, the pixel data output part 121 outputs charges accumulated in the second pixel lines 2n+1 as an accumulated value S(2n+1) of pixel values after the mechanical rear shutter 113 travels above the second pixel lines 2n+1. S(2n) corresponds to first pixel data and S(2n+1) corresponds to second pixel data.

A computation part 142 computes a first calibration value β(2n) and a second calibration value β(2n+1) based on S(2n), S(2n+1), t1, and t2. The computation part 142 may constitute a part of the image signal processing circuit 140, and may constitute a part of the control circuit 150. An example of a computation technique for β(2n) and β(2n+1) is as shown in the following. First, if S(2n) in the case where the mechanical rear shutter 113 travels ideally is assumed to be S0(2n), the following Equation (1) is satisfied.

(S(2n)−S(2n+1))/S0(2n)=t2/t1 Equation (1)

Here, when the first pixel lines 2n and the second pixel lines 2n+1 are sufficiently close to each other (for example, they are adjacent to each other as shown in FIG. 3), the pixel lines are regarded as the same area on a subject. When the following Equation (2) is satisfied, β(2n) denotes a calibration value in the first pixel lines 2n.

β(2n)=S0(2n)/S(2n) Equation (2)

By using Equation (2), the following Equation (3) is satisfied.

β(2n)=((S(2n)−S(2n+1))·t1)/(S(2n)·t2) Equation (3)

Likewise, the calibration value β(2n+1) of the second pixel lines (2n+1) is computed as in the following Equation (4).

β(2n+1)=((S(2n)−S(2n+1))·t1)/(S(2n+1)·t2) Equation (4)

Here, the computed β(2n) and β(2n+1) vary. For example, β(2n) may be a calibration value for calibrating a gain of S(2n), and β(2n+1) may be a calibration value for calibrating a gain of S(2n+1). In this case, a calibration part 143 constituting a part of the image signal processing circuit 140 may calibrate pixel values of the first pixel lines 2n based on β(2n) and calibrate pixel values of the second pixel lines (2n+1) based on β(2n+1) at the same time.

For example, the calibration part 143 may add or overlap β(2n) to pixel values of the first pixel lines 2n to calibrate the pixel values of the first pixel lines 2n and add or overlap β(2n+1) to pixel values of the second pixel lines 2n+1 to calibrate the pixel values of the second pixel lines 2n+1 at the same time. Through the calibration, an exposure unevenness is reduced and an exposure level itself is calibrated to an exposure level for an ideal exposure time.

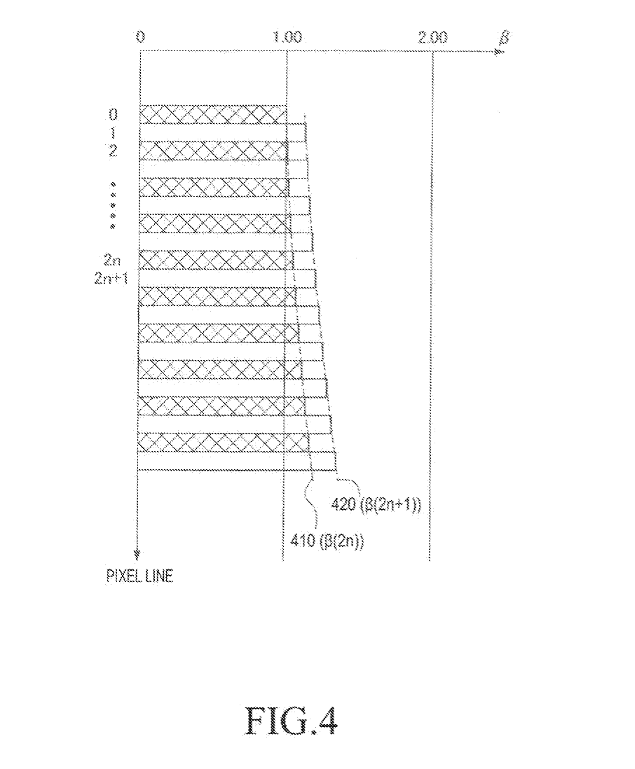

Although the calibration part 143 may apply β(2n) directly to pixel values of the first pixel lines 2n and β(2n+1) directly to pixel values of the second pixel lines 2n+1, it is possible to generate an error deviating from an average value between the adjacent pixel lines, due to an influence of noise. Thus, as shown in FIG. 4, the calibration part 143 may smooth a calibration value by using interpolation such as spline processing for β(2n) 410 and β(2n+1) 420.

The computation part 142 may calculate a time gap t3(2n) between travel characteristics of an ideal mechanical rear shutter and travel characteristics of an actual mechanical rear shutter in the first pixel lines 2n as a calibration value by using the following Equation (5).

t3(2n)=((S(2n)−S(2n+1))·t1−S(2n)·t2)/(S(2n)−S(2n+1)) Equation (5)

The computation part 142 may calculate a time gap t3(2n+1) between travel characteristics of an ideal mechanical rear shutter and travel characteristics of an actual mechanical rear shutter in the second pixel lines 2n+1 as a calibration value by using the following Equation (6).

t3(2n+1)=((S(2n)−S(2n+1))·t1−S(2n+1)·t2)/(S(2n)−S(2n+1)) Equation (6)

The calibration part adds t3(2n) to the travel characteristics of the first electronic front shutter 131, and may perform calibration such that a difference between the travel characteristics of the first electronic front shutter 131 and the travel characteristics of the mechanical rear shutter 113 cannot increase. Further, the calibration part 143 may add t3(2n+1) to the travel characteristics of the second electronic front shutter 132 to perform calibration such that a difference between the travel characteristics of the second electronic front shutter 132 and the travel characteristics of the mechanical rear shutter 113 cannot increase.

More specifically, the calibration part 143 may use t3(2n) to calibrate a first exposure time, for example, used during the next photographing operation and may use t3(2n+1) to calibrate a second exposure time used during the next photographing operation. Then, in order to distinguish the first and second exposure times used during the next photographing operation from the first and second exposure times used during the current photographing operation, the first and second exposure times used during the current photographing operation are also referred to as third and fourth exposure times.

The calibrated result may be reflected to the travel characteristics of the next photographing operation. For example, the calibrated result is acquired by the control circuit 150 through the SDRAM 171, and is used to control the next reset signal transmitting timing from the timing control part 151 to the image pickup device 120 to be reflected to the travel characteristics of the electronic front shutter during the next photographing operation.

The calibration part 143 may, for example, subtract t3(2n) from t1 to calibrate a first exposure time used during the next photographing operation, and may subtract t3(2n+1) from t1−t2 to calibrate a second exposure time used during the next photographing operation. In this way, the calibration part may reflect t3(2n) and t3(2n+1) calculated through the current photographing operation to the travel characteristics of the next photographing operation as it is. However, it can be expected that t3(2n) and t3(2n+1) includes an influence of an incidence angle caused by an aperture value and a focal distance in addition to a change in travel characteristics of the mechanical rear shutter due to a posture difference, a temperature, and the like. Thus, the calibration part 143 may reflect a plurality of past values of t3(2n) and t3(2n+1) to the travel characteristics during the next photographing operation. In this case, for example, an average value of the plurality of past values may be employed.

When an average value of a plurality of post values are employed, the calibration part 143 may, for example, subtract an average value of a plurality of past values of t3(2n) from t1 to calibrate a first exposure time used during the next photographing operation, and subtract an average value of a plurality of next values of t3(2n+1) from t1−t2 to calibrate a second exposure time used during the next photographing operation. In this way, it is expected that an error is further reduced by using an average value of a plurality of past values.

A method of applying a technology of alternately changing exposure time for pixel lines to photographing of a wide dynamic range image is disclosed in Japanese Unexamined Patent Publication No. 2008-228573.

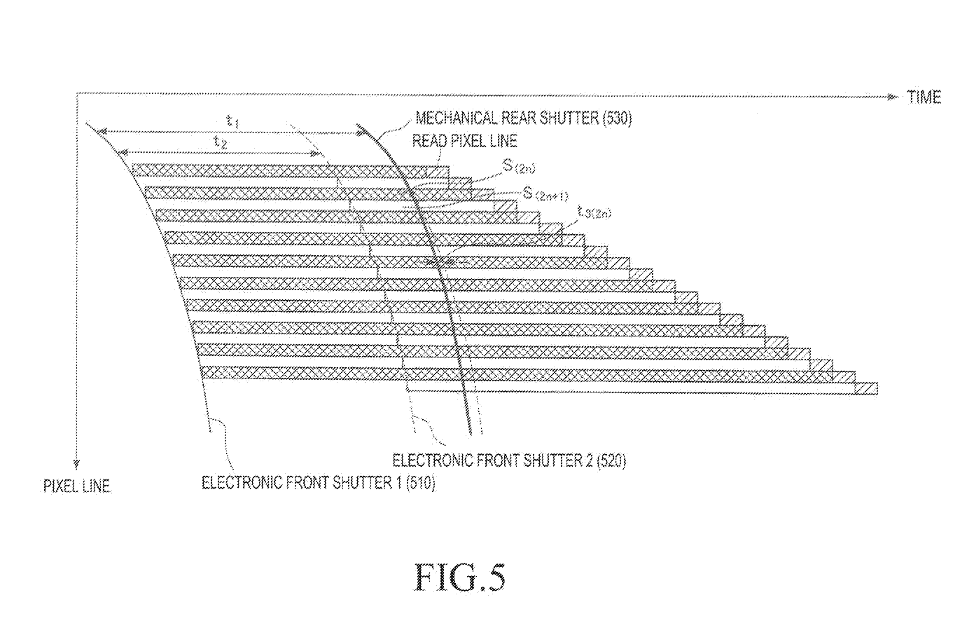

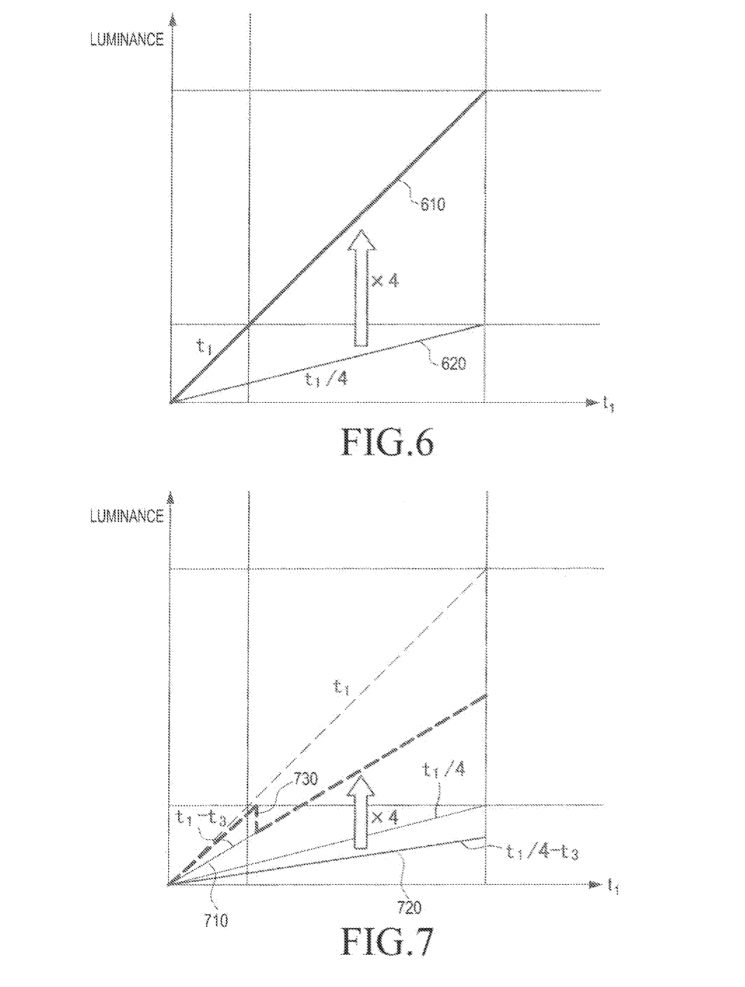

FIG. 5 is a diagram illustrating a chart for explaining an application of calibration values to expansion of a dynamic range according to an embodiment of the present invention. FIG. 6 is a graph illustrating a synthesis result of pixel values when an exposure unevenness is not generated according to an embodiment of the present invention. FIG. 7 is a graph illustrating a synthesis result of pixel values when an exposure unevenness is generated according to an embodiment of the present invention.

FIG. 5 shows an exposure starting timing line 510 by the first electronic front shutter 131, an exposure starting timing line 520 by the second electronic front shutter 132, and a light shielding timing line 530 by the mechanical rear shutter 113.

For example, if an exposure time of the first pixel lines 2n is assumed to be t1 and an exposure time of the second pixel lines 2n+1 is assumed to be t1−t2=t1/4 as shown in FIG. 5, a dynamic range of 12 dB can be expanded by synthesizing a result obtained by multiplying an image value 620 of the second pixel lines 2n+1 by four with an image value 610 of the first pixel lines 2n as shown in FIG. 6. Then, an image value represents a luminance of an image.

As shown in FIG. 6, although a fourfold increase of the image value results in an ideal synthesis, actually, a problem is caused by an exposure unevenness due to the travel characteristics of the electronic front shutter and the travel characteristics of the mechanical rear shutter. As shown in FIG. 7, since an exposure time in the first pixel lines 2n is t1−t3 and an exposure time in the second pixel lines 2n+1 is t1/4−t3 when a shutter error is t3, a step in luminance is generated and an unnatural synthesis image 730 is created when a result obtained by multiplying an image value 720 of the second pixel lines 2n+1 by four is synthesized with an image value 710 of the first pixel lines 2n.

In order to solve the problem, through the above-described technique, calibration values β(2n) and β(2n+1) is computed and calibration values β(2n) and β(2n+1) is applied. In more detail, the image pickup apparatus 10 further includes a synthesizing part 144 for synthesizing a result obtained by calibrating pixel values of the first pixel lines 2n based on the calibration value β(2n) with a result obtained by calibrating pixel values of the second pixel lines 2n+1 based on a second calibration value. If the synthesis is made, a luminance step itself is reduced and a wide dynamic range image having an excellent quality is synthesized. The synthesis part 144 may constitute a part of the image signal processing circuit 140.

As described above, when a still image is photographed by using an electronic front shutter and a mechanical rear shutter, an image pickup apparatus 10 according to an embodiment of the present invention alternates timings of the electronic front shutter for pixel lines by a preset time during an exposure and compares pixels of pixel lines whose exposure states are different from each other to compute a gain calibration value for reducing an exposure unevenness. The exposure unevenness problem becomes significant, especially, in the case of a high speed shutter.

Further, when using the image pickup apparatus 10, an exposure unevenness is reduced by calibrating gains for pixel lines. Further, when the image pickup apparatus 10, a change in the characteristics of the mechanical shutter due to a lapse of time is precisely calibrated by feeding back a calibration computation result during the current photographing operation to control of the electronic front shutter timing during the next photographing operation. Further, when using the image pickup apparatus 10, when a high dynamic range image is synthesized by using a plurality of images whose exposure states are different from each other, a calibration value is computed likewise and a synthesis is processed by using the calibration value to obtain a precise synthetic image.

According to embodiments of the present invention, a gain of an exposure unevenness can be calibrated according to conventional or other techniques from an image which can be obtained by alternating starting times of the electronic front shutter for pixel lines during a capture of an image.

Further, even when a synthesis for obtaining a wide dynamic range image is processed, a gain of an image before the synthesis is calibrated and synthesized according to the embodiment of the present invention to be precisely synthesized.

As described above, according to embodiments of the present invention, an image in which exposure times are different for pixel lines can be created by changing accumulation times of charges for pixel lines having a preset pixel width and calibration values for precisely reducing an exposure unevenness can be computed based on the image.

It is apparent that the embodiments of the present invention may be realized in hardware, software, or a combination thereof. Software may be stored in a volatile or nonvolatile storage unit such as a storage unit including a Read-Only Memory (ROM) regardless of whether information can be erasable therefrom or re-recordable therein, a memory such as a RAM, a memory chip, a unit or an integrated circuit, and a optically or magnetically recordable and machine (for example, a computer)-readable storage medium such as a magnetic disk or a magnetic tape.

Memory included in the image pickup apparatus is an example of a storage medium that can be read by a machine suitable for storing a program or programs including instructions according to embodiments of the present invention. Thus, embodiments of the present invention may include a program including code for performing a method according to an embodiment of the present invention and a storage medium that can be read by a machine for storing such a program. Further, the program may be electronically fed though an arbitrary medium such as a communication signal transferred through a wired or wireless connection, and the present includes its equivalent.

An image pickup apparatus according to embodiments of the present invention may receive and store the program from a program providing apparatus via a wired or wireless connection. The program providing apparatus may include a memory for storing a program including instructions for allowing the image pickup apparatus to perform the image pickup method, other information, or data, a communication part for performing a wired or wireless communication with the image pickup apparatus, and a control part for transmitting the corresponding program to the image pickup apparatus in response to a request of the image pickup apparatus or automatically.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. An image pickup apparatus comprising:
an image pickup device comprising a first pixel line and a second pixel line, each of which has a plurality of pixels;
a first resetting part for performing a first reset operation with respect to a charge accumulated in the first pixel line;
a second resetting part for performing a second reset operation with respect to a charge accumulated in the second pixel line;
a travel control part for traveling a light shielding member above the first pixel line when a first exposure time elapses from the first reset operation, and traveling the light shielding member above the second pixel line when a second exposure time elapses from the second reset operation;
a pixel data output part for outputting the charge accumulated in the first pixel line as first pixel data for a current photographing operation after the light shielding member travels above the first pixel line, and outputting the charge accumulated in the second pixel line as second pixel data for the current photographing operation after the light shielding member travels above the second pixel line; and
a computation part for computing a first calibration value for the first pixel line and a second calibration value for the second pixel line based on the first pixel data, the second pixel data, the first exposure time, and the second exposure time.

2. The image pickup apparatus of claim 1, wherein the computation part computes a first calibration value for calibrating the first pixel data of the first pixel line, and a second calibration value for calibrating the second pixel data of the second pixel line.

3. The image pickup apparatus of claim 2, further comprising:
a calibration part for calibrating the first pixel data of the first pixel line based on the first calibration value and calibrating the second pixel data of the second pixel line based on the second calibration value.

4. The image pickup apparatus of claim 3, further comprising:
a synthesis part for synthesizing a result obtained by calibrating the first pixel data of the first pixel line based on the first calibration value and a result obtained by calibrating the second pixel data of the second pixel line based on the second calibration value.

5. The image pickup apparatus of claim 1, wherein the computation part computes a first calibration value for calibrating a third exposure time applied to the first pixel line during a next photographing operation, and computes a second calibration value for calibrating a fourth exposure time applied to the second pixel line during the next photographing operation.

6. The image pickup apparatus of claim 5, further comprising:
a calibration part for calibrating the third exposure time used during the next photographing operation based on the first calibration value and calibrating the fourth exposure time used during the next photographing operation based on the second calibration value.

7. An image pickup method comprising:
performing a first reset operation with respect to a charge accumulated in a first pixel line of an image pickup device, each of the first and second pixel lines having a plurality of pixels;
performing a second reset operation with respect to a charge accumulated in the second pixel line;
traveling a light shielding member above the first pixel line when a first exposure time elapses from the first reset operation, and traveling the light shielding member above the second pixel line when a second exposure time elapses from the second reset operation;
outputting the charge accumulated in the first pixel line as first pixel data for a current photographing operation after the light shielding member travels above the first pixel line, and outputting the charge accumulated in the second pixel line as second pixel data the current photographing operation after the light shielding member travels above the second pixel line; and
computing a first calibration value for the first pixel line and a second calibration value for the second pixel line based on the first pixel data, the second pixel data, the first exposure time, and the second exposure time.

8. The image pickup method of claim 7, wherein a first calibration value for calibrating first pixel data of the first pixel line and a second calibration value for calibrating second pixel data of the second pixel line are computed.

9. The image pickup method of claim 8, further comprising:
calibrating the first pixel data of the first pixel line based on the first calibration value and calibrating the second pixel data of the second pixel line based on the second calibration value.

10. The image pickup method of claim 9, further comprising:
synthesizing a result obtained by calibrating the first pixel data of the first pixel line based on the first calibration value and a result obtained by calibrating the second pixel data of the second pixel line based on the second calibration value.

11. The image pickup method of claim 7, wherein a first calibration value for calibrating a third exposure time applied to the first pixel line during a next photographing operation and a second calibration value for calibrating a fourth exposure time applied to the second pixel line during the next photographing operation are computed.

12. The image pickup method of claim 11, further comprising:
calibrating the third exposure time used during the next photographing operation based on the first calibration value and calibrating the fourth exposure time used during the next photographing operation based on the second calibration value.

13. A non-transitory machine-readable storage medium that records a program for executing an image pickup method comprising:
performing a first reset operation with respect to a charge accumulated in a first pixel line of an image pickup device, each of the first and second pixel lines having a plurality of pixels;
performing a second reset operation with respect to a charge accumulated in the second pixel line;
traveling a light shielding member above the first pixel line when a first exposure time elapses from the first reset operation, and traveling the light shielding member above the second pixel line when a second exposure time elapses from the second reset operation;
outputting the charge accumulated in the first pixel line as first pixel data for a current photographing operation after the light shielding member travels above the first pixel line, and outputting the charge accumulated in the second pixel line as second pixel data the current photographing operation after the light shielding member travels above the second pixel line; and
computing a first calibration value for the first pixel line and a second calibration value for the second pixel line based on the first pixel data, the second pixel data, the first exposure time, and the second exposure time.

14. The image pickup method of claim 13, wherein a first calibration value for calibrating first pixel data of the first pixel line and a second calibration value for calibrating second pixel data of the second pixel line are computed.

15. The image pickup method of claim 14, further comprising:
calibrating the first pixel data of the first pixel line based on the first calibration value and calibrating the second pixel data of the second pixel line based on the second calibration value.

16. The image pickup method of claim 15, further comprising:
synthesizing a result obtained by calibrating the first pixel data of the first pixel line based on the first calibration value and a result obtained by calibrating the second pixel data of the second pixel line based on the second calibration value.

17. The image pickup method of claim 13, wherein a first calibration value for calibrating a third exposure time applied to the first pixel line during a next photographing operation and a second calibration value for calibrating a fourth exposure time applied to the second pixel line during the next photographing operation are computed.

18. The image pickup method of claim 17, further comprising:
calibrating the third exposure time used during the next photographing operation based on the first calibration value and calibrating the fourth exposure time used during the next photographing operation based on the second calibration value.
